(19) United States
(12) Patent Application Publication
(10) Pub. No.: US 2008/0313545 A1
(43) Pub. Date: Dec. 18, 2008

(54) SYSTEMS AND METHODS FOR PROVIDING DESKTOP OR APPLICATION REMOTING TO A WEB BROWSER

(75) Inventors: Jeson Patel, Seattle, WA (US); Nadim Abdo, Bellevue, WA (US); Robert-Wilhelm Schmieder, Snoqualmie, WA (US)

Correspondence Address: LEE & HAYES PLLC, 421 W RIVERSIDE AVENUE SUITE 500, SPOKANE, WA, 99201, US

(73) Assignee: MICROSOFT CORPORATION, Redmond, WA (US)

(21) Appl. No.: 11/762,164

(22) Filed: Jun. 13, 2007

(51) Int. Cl. G06F 3/00

(52) U.S. Cl. 715/738

(57) ABSTRACT

Systems and methods (“tools”) are described that enable a user to access and interact with a remote desktop or application without the need to install a plug-in or software in addition to a web browser. In some embodiments, the tools include double buffering graphics that display the remote desktop or application, and caching images that are repeated. These tools may also include identifying the portion of the desktop or application that has changed and then transmitting the changed portion.

### BACKGROUND

Currently, many users interact with network-enabled applications. A user on a home computer, for instance, may interact with a web browser application to view web pages over the Internet. Other users may use a remote desktop application to access a remote computer while traveling or tele-commuting.

The current solution of providing desktop/application remoting through the web, as provided by Microsoft, involves loading an ActiveX control within the web browser. Specifically, the Microsoft solution is called the TS Client ActiveX control, and is the same control that powers other network-enabled applications, including Remote Desktop, Remote Web Connection, Remote Programs, Remote Assistance, and Windows Meeting Spaces.

ActiveX controls are Operating System (OS) and architecture dependent components, and are not supported by all web browsers. In addition to these limitations, if the end user does not already have the ActiveX control installed, they would be required to install it before they can use the remote desktop or application. Installation may raise a number of security concerns. Additionally, users would be required to have the permissions or privileges on the machine to actually do the installation. The users may also not understand security implications of installing the component. The control running on their machine may enable access to parts of their system that may be considered secure from the user's perspective.

### SUMMARY

Techniques disclosed herein address the problem of providing desktop and application remoting by providing a solution with platform independence and no user installation. The web browser is the primary end-user delivery mechanism.

In one implementation, web/web-browser based technology is leveraged to deliver a remoting solution similar to the traditional ActiveX control without requiring users to install any additional components. The user experience would be similar to visiting a conventional web page where the user would see graphics, text, and could fill out and submit forms. From a remote application perspective, the images on a web page appear to be updated as the remote application's “display” changes, and upon receiving input from the web page for the remote application to interact with.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the use of the same reference numbers in different figures indicates similar or identical items.

FIG. 1 illustrates an exemplary operating environment in which a terminal server is separate from a web server.

FIG. 2 illustrates an exemplary operating environment where a terminal server is combined with a web server.

FIG. 3 illustrates an exemplary data flow for the system shown in FIG. 1.

FIG. 4 illustrates an exemplary data flow for the system shown in FIG. 2.

FIG. 5 illustrates a first exemplary process for updating graphics data.

FIG. 6 is a second exemplary process for updating graphics data.

FIG. 7 is a third exemplary process for updating graphics data.

FIG. 8 is an exemplary process for updating a graphics display using double buffering.

FIG. 9 is a second exemplary process for updating a graphics display using double buffering.

FIG. 10 is an example of a process that may be used to cache graphics data.

FIG. 11 is a second example of a process that may be used to cache graphics data.

FIG. 12 is an example of a process that may be used to batch input events.

### DETAILED DESCRIPTION

### Overview

The following document describes systems and methods that enable a user to access a remote desktop or application using a browser without having to install remote desktop or remote application software or plug-ins. The techniques described herein may provide significant improvements over the current state of the art, potentially providing greater usability of server and server systems, reduced bandwidth costs, and an improved client experience with remote desktops or applications

More specifically, systems and methods (or “tools”) disclosed herein may be capable of providing (1) desktop and application remoting using a web browser as the primary end-user delivery mechanism; (2) an environment that does not require the user to install components; and (3) and platform independence. Exemplary environments in which these tools may enable these and other techniques are described below, followed by other sections describing various inventive techniques and exemplary embodiments of the tools.

### Exemplary Operating Environment

Before describing the tools in detail, the following discussion of two exemplary operating environments is provided to assist the reader in understanding two examples of ways in which various inventive aspects of the tools may be employed. The environments described below constitute but two examples and are not intended to limit application of the tools to any particular operating environment. Other environments may be used without departing from the spirit and scope of the claimed subject matter.

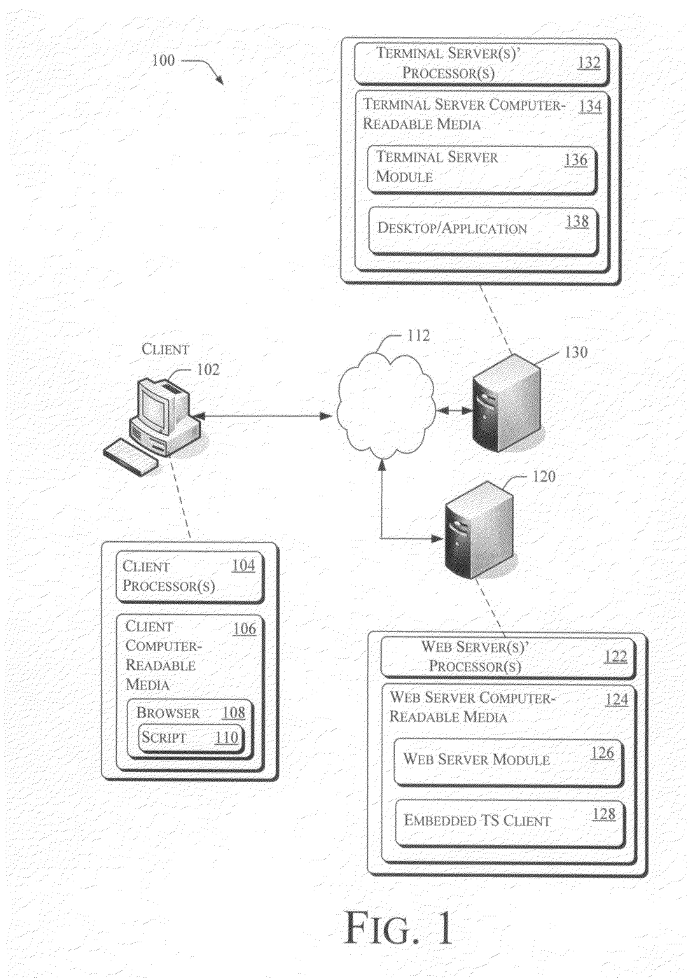

FIG. 1 illustrates one such operating environment generally at 100. Operating environment 100 may include a client 102 having one or more client processor(s) 104 and client computer-readable media 106. The client 102 comprises a computing device, such as a cell phone, desktop computer, personal digital assistant, or server. The processors 104 are capable of accessing and/or executing instructions stored on the computer-readable media 106. The computer-readable media 106 comprises or has access to a browser 108, which is a module, program, or other entity capable of interacting with a network-enabled entity. The browser 108 may be capable of running or responding to one or more scripts 110. One example of browser 108 is a web browser.

The operating environment also includes a network 112 that is connected to the client 102, a web server 120, and a terminal server 130. The network 112 enables communication between the client 102 and the web server 120, and can comprise a global or local network (wired or wireless), such as the Internet or a company's intranet. The network 112 also enables communication between the web server 120 and the terminal server 130.

The web server 120 may include a web server processor(s) 122 and web server computer-readable media 124. The web server processor(s) 122 are capable of accessing and/or executing instructions stored on the web server computer-readable media 124. The web server computer-readable media 124 includes or has access to a web sever module 126 and an embedded terminal server (TS) client 128. The web server 120 in FIG. 1 is shown with all of these elements for the sake of illustration, though one or more of these elements may be spread over individual servers or other entities comprised by web sever 120, such as another computing device that acts to govern a web server farm.

The terminal server 130 may include a terminal server processor(s) 132 and terminal server computer-readable media 134. The terminal server processor(s) 132 are capable of accessing and/or executing instructions stored on the terminal server computer-readable media 134. The terminal server computer-readable media 134 includes or has access to a terminal sever module 136 and a desktop (or application) 138. The terminal server 130 in FIG. 1 is shown with all of these elements for the sake of illustration, though one or more of these elements may be spread over individual servers or other entities comprised by terminal sever 130, such as another computing device that acts to govern a terminal server farm.

In operation, the input received by client 102 is transmitted to web server 120. The web server 120 then transmits the input to the terminal server 130 using the embedded terminal server client 128. Updated graphics from the desktop or application 138 are sent from the terminal server 130 to the web server 120. The embedded terminal server client 128 and web server module 126 cooperate to serve the updated graphics as an updated web page to the client 102. An advantage of this design is that a web server would be able to connect to multiple terminal servers, however, there would be a larger latency since there is a web server between the client 102 and the terminal server 130 in comparison to traditional Remote Desktop/Terminal Server scenario where the client communicated directly to the terminal server.

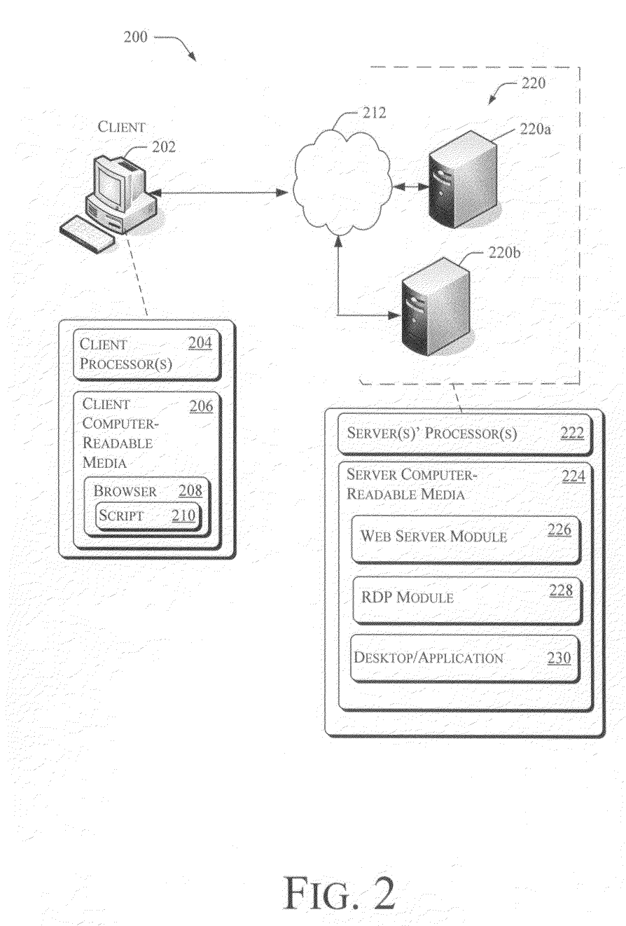

FIG. 2 illustrates a second such operating environment generally at 200. Compared to the embodiment shown in FIG. 1, this embodiment doesn't suffer from the extra latency from the extra hop from the web server 120 to the terminal server 130, however, in the operating environment 200, the web server 120 may be limited to interacting with the terminal server 130 on the same machine or server farm.

Operating environment 200 may include a client 202 having one or more client processor(s) 204 and client computer-readable media 206. The client 202 comprises a computing device, such as a cell phone, desktop computer, personal digital assistant, or server. The processors 204 are capable of accessing and/or executing instructions stored on the computer-readable media 204. The computer-readable media 204 comprises or has access to a browser 208, which is a module, program, or other entity capable of interacting with a network-enabled entity. The browser 208 may be capable of running or responding to one or more scripts 210.

The operating environment 200 also includes a network 212 that is connected to the client 202 and server 220. The network 212 enables communication between the client 202 and the server 220, and can comprise a global or local network (wired or wireless), such as the Internet or a company's intranet.

The server 220 may include a server processor(s) 222 and server computer-readable media 224. The server processor(s) 222 are capable of accessing and/or executing instructions stored on the server computer-readable media 224. The server computer-readable media 224 includes or has access to a web sever module 226, a Remote Desktop or Application Processing (RDP) module 228 and a desktop (or application) 230. Again, the server in FIG. 2 is shown with all of these elements for the sake of illustration, though one or more of these elements may be spread over individual servers 220a and 220b or other entities comprised by sever 220, such as another computing device that acts to govern a server farm.

### Data Flow

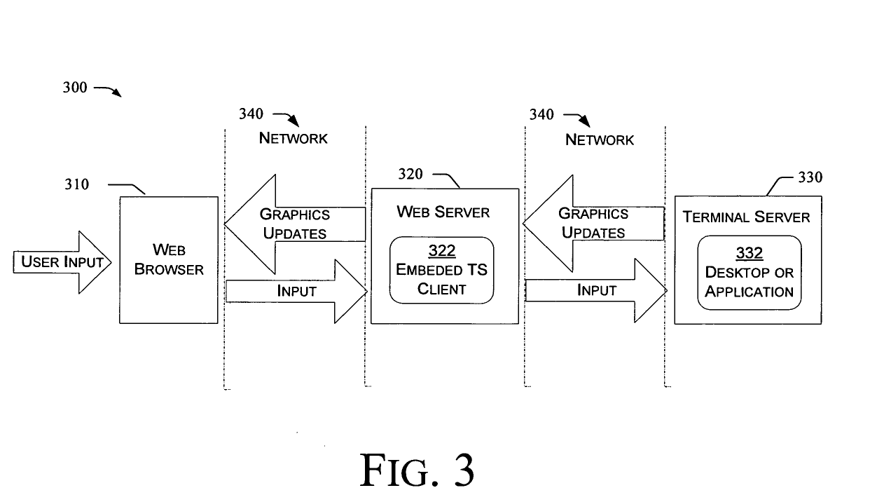

FIG. 3 illustrates an exemplary embodiment of a flow of data 300 for the operating environment 100 shown in FIG. 1. Thus, FIG. 3 illustrates an exemplary data flow 300 between a web browser 310 and a web server 320, and between the web server 320 and terminal server 330. This data flow 300 enables the user 102 to interact with a remote desktop/application 332 via the web-browser 310.

In the embodiment shown in FIG. 3, a script running within the web-browser 310 would collect input events (e.g. keystroke and mouse events) from user input, and send them to the web-server 320 via network 340. Typically the script (e.g. script 110 of FIG. 1) would convert the input events to HTTP and then send the input events as HTTP over the network 340. In some embodiments the script may use the XMLHTTP object to send the data to the server.

In this embodiment, the actual remote desktop/application 332 is running on the terminal server 330, therefore the web-server 320 relays the input data to the terminal server 330 using the embedded terminal server (TS) client 322. Thus, the web-server 320 can be considered a translation layer between HTTP and RDP. The web-server 320 would be running an implementation of an embedded TS client 322 in order to communicate to the terminal server 330 through RDP.

In the embodiment shown in FIG. 3, the graphics data originates at the terminal server 330 since that is where the actual remote desktop or application 332 is running. The terminal server 330 transmits a graphical representation of the desktop and/or application 332 to the embedded TS Client 322 running in the web-server 320. The web-server 320, would then take this graphics data, convert it into a standard image format that a web-browser 310 could render (e.g., jpeg, gif, png). The graphics data would then be sent to the web-browser 310, and the web-browser 310 would use the image to update the graphic representation of the desktop.

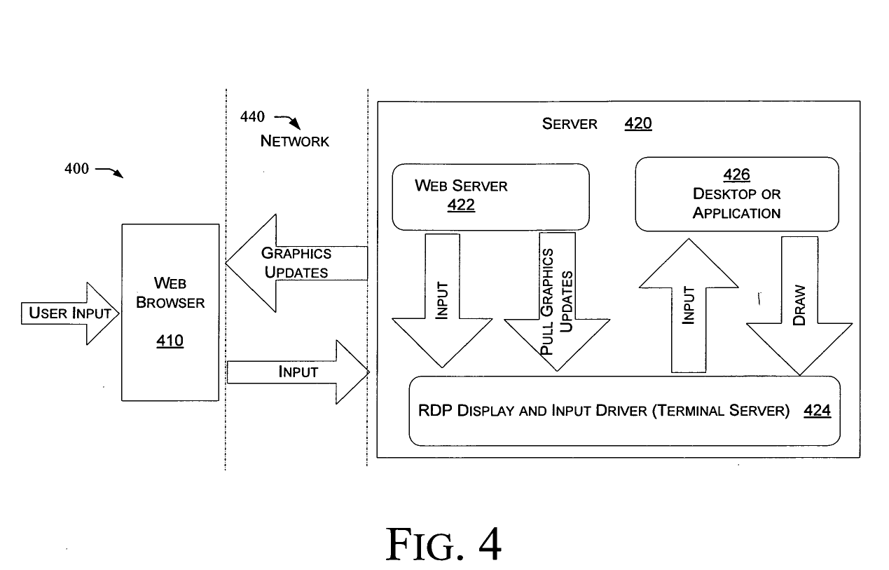

FIG. 4 illustrates an exemplary embodiment of a data flow 400 for the operating environment shown in FIG. 2. Thus, FIG. 4 illustrates an exemplary data flow 400 between a web browser 410 and a server 420, and with in the server 420. This data flow 400 enables the user to interact with a remote desktop/application 426 via the web-browser 410.

In the embodiment shown in FIG. 4, a script running within the web-browser 410 would collect input events (e.g. keystroke and mouse events) from user input, and send them to the server 420 via network 440. Typically, the script converts the input events to HTTP and then sends the input as HTTP over the network 440. In other embodiments the input events may be sent to the server 420 using other communication protocols.

In this embodiment, the actual remote desktop/application 426 is running on the same server 420 as the web-server 422. The web-server 422 relays the input data to the input driver in the RDP display and an input driver 424 associated with the user's session. The RDP display and input driver 424 will then send the input into the user's session in the desktop or application 426.

Graphics data originates at the server 420 running the web server 422 since it is the same server running the remote desktop/applications 426. When the desktop/application 426 changes, the web-server 422 may be notified of the change or update. At this point, the web server 422 may request the RDP display and input driver 424 for the updated graphics data. The web-server 422, after receiving the updated graphics data, converts the graphics data into a standard image format that a web-browser could render (e.g., jpeg, gif, png). The graphics data would then be sent to the web-browser 410, and the web-browser 410 uses the image to update its graphics representation of the desktop/application 426. In other embodiments, the desktop or application 426 could send the updated graphics data to the RDP display and input driver 424. The RDP display and input driver 424 could then forward this graphics data to the web-server 422.

### Dynamically Updating Graphics at the Web-Browser

Generally speaking, in order to maintain an accurate graphical representation of a remote desktop or application, a web page operating in accordance the teachings of the present disclosure receives images from a web-server through HTTP, and then dynamically updates the portion of its representation that has changed. This can be done by using Asynchronous JavaScript and XML (AJAX) or other similar technology.

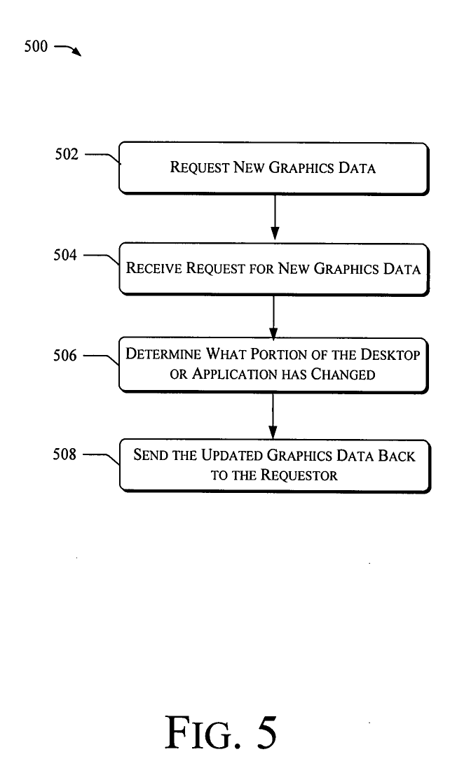

For example, FIG. 5 illustrates an exemplary series of steps 500 that may be used to maintain an accurate graphical representation of a remote desktop or application. In block 502 a web browser running on a client may request new graphics data. For example, a script running in the web-browser could make an HTTP request using the XMLHTTP object to ask a server for ‘new graphics data’. In block 504, a server receives the request for new graphics data. In block 506, the server could determine what portion of the desktop or application has changed. In block 508, the server could send the data back in a standard image format that the web-browser can render.

By using techniques in accordance with the present disclosure, the web-page could make this request, get the new image data, and update the web-browser, without refreshing (e.g. reloading) the page.

### Image Transmission

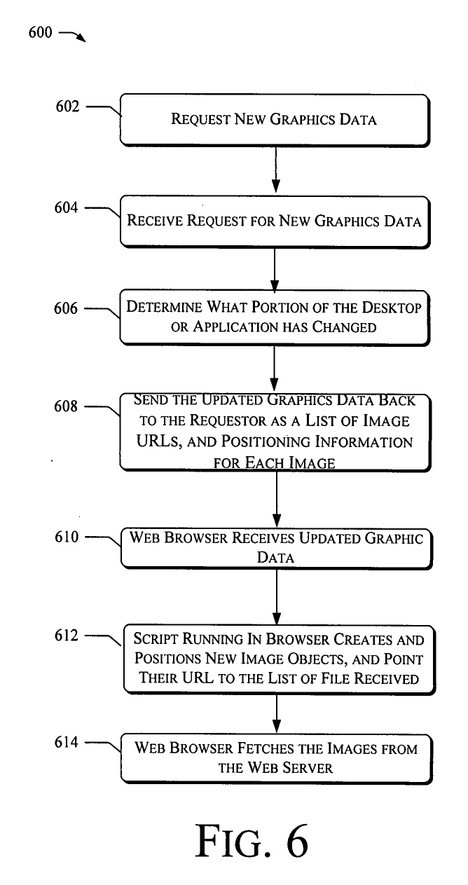

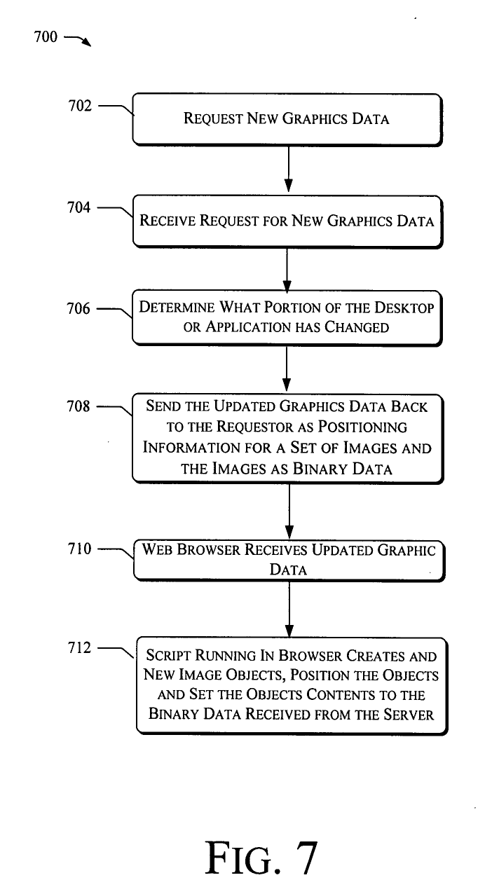

Two examples of mechanisms or processes that a browser may use to get the graphics data in accordance with the teachings of the present disclosure are shown in FIGS. 6 and 7. In the example shown in FIG. 6, the web-browser asks for ‘new graphics data’ in block 602. For example, a script running in the web-browser could make an HTTP request using the XMLHTTP object to ask a server for ‘new graphics data’. In block 604, a server receives the request for new graphics data. In block 606, the server could determine what portion of the desktop or application has changed. In block 608, the server could send the data back in a standard image format that the web-browser can render.

In this embodiment, the server could send the updated graphics data to the browser as a list of image URLs, along with positioning information for each image, in block 608. After the web browser receives the updated graphic data in block 610, a script running in the web browser creates new ‘image objects’, positions them correctly, and points their URL to a list of file names received in block 612. The web-browser then goes back to the web-server and fetches the images in block 614.

Similarly, in the example shown in FIG. 7, the web-browser asks for ‘new graphics data’ in block 702. For example, a script running in the web-browser could make an HTTP request using the XMLHTTP object to ask a server for ‘new graphics data’. In block 704, a server receives the request for new graphics data. In block 706, the server could determine what portion of the desktop or application has changed. In block 708, the server could send the data back in a standard image format that the web-browser can render.

In this embodiment, the server could respond by sending position information for a set of images, and the images themselves as binary data in block 708. In one embodiment the binary data is sent using Base64 encoding. After the web browser receives the updated graphic data in block 710, a script running in the web browser creates new ‘image objects’, positions them correctly, and sets the image's contents to the binary data received from the server in block 712.

### Size of Updates

Two possible methods of sizing image updates may be used: uniform tiles and non-uniform tiles. When using uniform tiles, the desktop/application is divided into a uniform grid of tiles. Each tile may have an index and be represented by an HTML DIV tag on the web page. In this scenario, DIVs can be thought of as positionable components within a web-page. The DIV would contain an image of the tile. When the web-server sends image data to the web-browser, script running on the web browser places the image in the proper DIV based on the index of the tile that it is updating.

When using non-uniform tiles, the web-server may send the web-browser non-uniform sized images along with their size and position in coordinates. The web page creates a DIV for the new image, and then sizes and positions it according to the data provided by the server. When a DIV is no longer visible, it typically is removed from the web page.

### Double Buffering

When an updated portion of a desktop/application is received, it typically replaces some existing portion of the desktop/application. In certain situations, this may cause a slight flicker because within a DIV the ‘image object’ is replaced by a new ‘image object’. When this happens there may be a moment where there is no image displayed at all. Double buffering may be used to fix this problem.

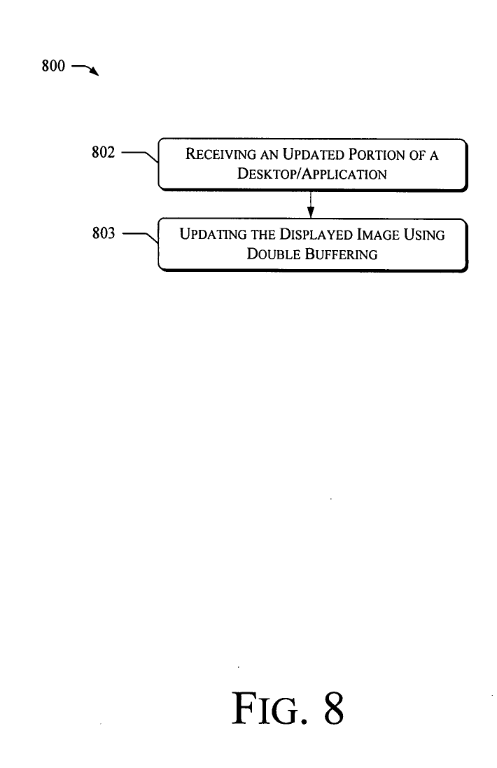

FIG. 8 illustrates an example of a process 800 that may be used to update the web page display. In block 802 the updated portion of the desktop/application is received. Thereafter in block 804 the displayed image is updated using double buffering.

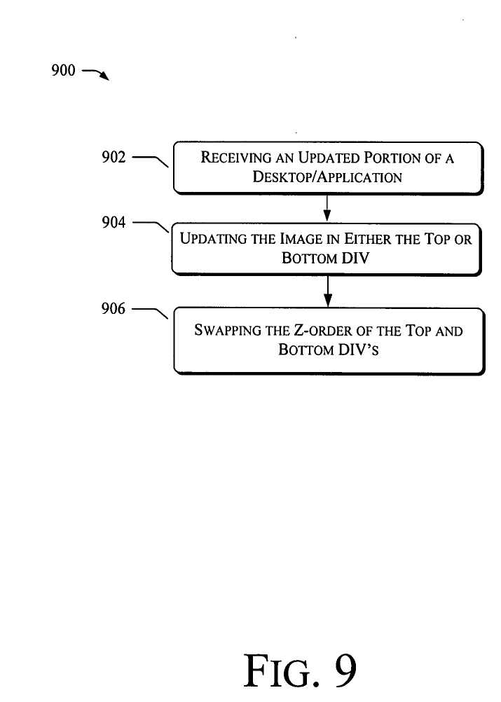

FIG. 9 illustrates one example of a double buffering process 900. The double buffering process involves having 2 layers of DIVs to represent the desktop/application. For each tile in the desktop/application, there will be a DIV marked as ‘top’ and one marked as ‘bottom’. When a new update is received in block 902, the image in either the ‘top’ or ‘bottom’ DIV is updated in block 904. Typically the ‘bottom’ DIV is updated. Thereafter, the z-order of the two DIVs are swapped in block 906. Thus, if the ‘bottom DIV was updated, this DIV now becomes the new ‘top’ DIV.

While the new image is loading, the other DIV will either be behind the new DIV, or on top of it (depending on how the browser handles updating the image and the DIV's z-order). If the new image is temporarily blank, you will either see through it if the other DIV is behind it, or be blocked by the other DIV if it's in front. Since you will always see an image, you will never see a flash of a missing image when a tile is being updated.

### Caching

When viewing a remote desktop/application there may be a number of images that are consistently repeated. For example, in Windows, the desktop background or Start Menu may change visibility a number of times during a session as the user interacts with the desktop. Client side caching in the web-browser would help improve the responsiveness of the changes in the desktop by caching frequently viewed components.

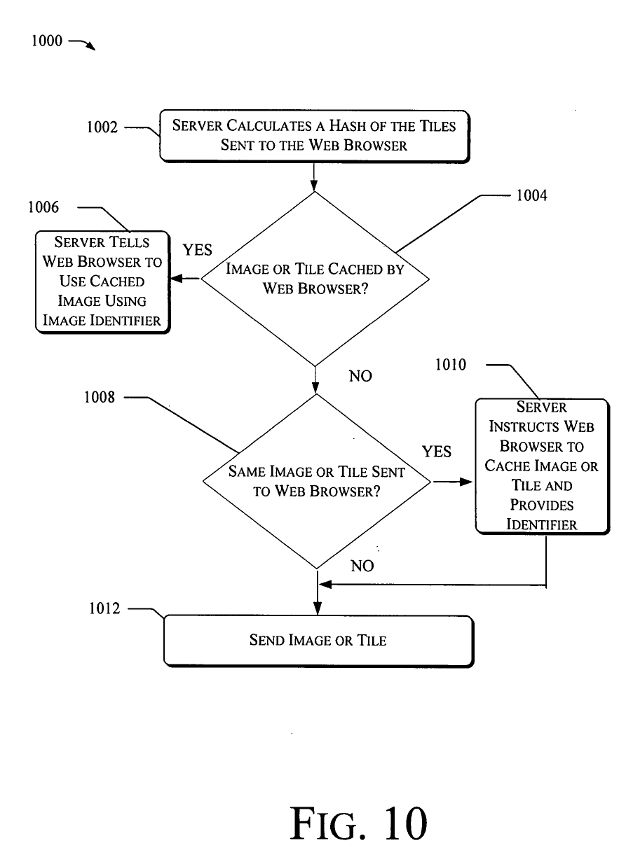

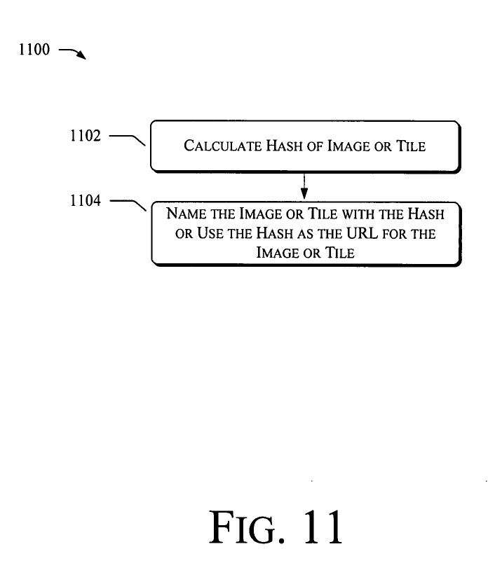

FIGS. 10 and 11 provide two exemplary mechanisms or processes for client side caching. In the process 1000 illustrated in FIG. 10, caching is directed by the server. In this situation, the server calculates a hash of the tiles or images sent to the web-browser in block 1002. CB64 is one example of a hash that may be used.

If the server recognizes that the tile or image is cached by the web-browser in block 1004, instead of sending the tile or image, the server will tell the web browser to use its cached copy of the tile or image using the image identifier in block 1006. When the image or tile is not stored in the web browser cache and the server recognizes that the same image has been sent to the web-browser in the past in block 1008, the server may tell the web-browser to cache the image and provides an identifier to identify the cached item in block 1010. In some embodiments, the identifier may be a unique identifier. In other embodiments, the identifier may be unique to the user or to the particular user's session. Thereafter, the image or tile is sent by the server in block 1012.

FIG. 11 provides a second example of mechanism for client side caching. In FIG. 11, process 1100 leverages the browser's inbuilt caching mechanism for images. Process 1100 may be used when the web-browser and web-server exchange graphics data through the file URL method as described above and shown in FIG. 6. In this process the server calculates a hash of the tile or image in block 1102. CB64 is one example of a suitable hash. Thereafter, the server could name the image files according to the hash value of the image in block 1104. By doing this, an image that is commonly repeated will always have the same image URL, and thus would be viewed by the web-browser as the same image, and would be cached by the web-browser.

### Batching Input at the Web-Browser

By using techniques in accordance with the present disclosure, a web-page can allow a user to provide input to a remote application. The web-page would wait for input events from the user (such as keystrokes and mouse events) and would make an HTTP request through the XMLHTTP object to the web-server, notifying it of the input events that have just occurred.

A simple approach for sending input from the web-browser to the web-server would be to listen for key stroke and mouse events, and make an HTTP request to the server through the XMLHTTP object for each input event. Since input typically occurs very frequently (imagine how many events are generated when the user just moves the mouse), making a separate request for each input event would be very inefficient.

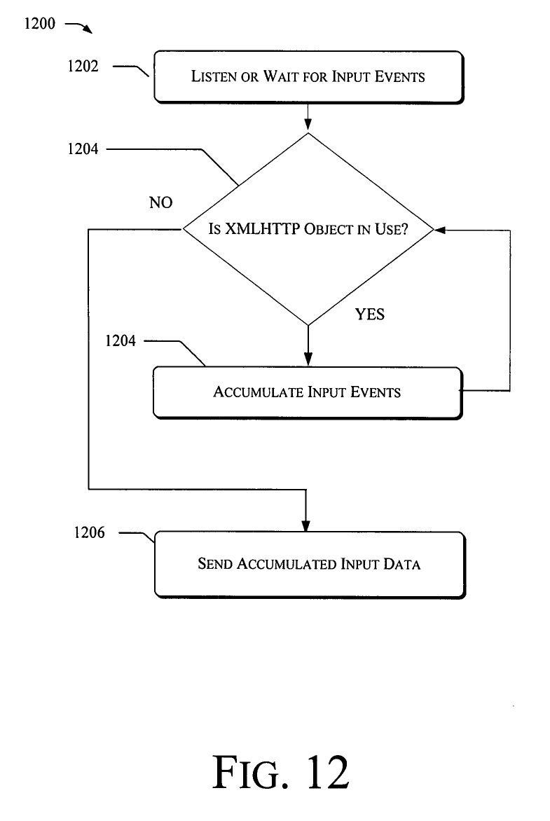

Instead of making a single request for each event, input batching may be used. FIG. 12 provides an exemplary process 1200 that may be used to provide input batching to the remote application. In the embodiment of the batching process shown in FIG. 12, the process 1200 waits for input events in block 1202. After receiving an input event the availability of the XMLHTTP object is checked in block 1204. In some embodiments it may be desirable to wait a predetermined time or for a predetermined number of input events before checking the availability of the XMLHTML object. If the XMLHTTP object is not in use, then any accumulated input data could be sent to the web-server in block 1206. When the XMLHTTP object is in use (i.e., we are in the middle of processing or sending past input events), the input data is accumulated in block 1204.

This mechanism maximizes the use of the HTTP connection by sending as much data as possible at the time of the connection. Depending on the limitation of number of XMLHTTP objects that are available, it is good practice to use a separate XMLHTTP objects for receiving graphics and sending input. This allows graphics and input to be sent and received in parallel. Input data may be accumulated in a list or array type data structure in the web-browser.

In some embodiments, when XMLHTTP object finishes transmitting data, it checks this data structure and issues a new request or reissues the request if there is data available in the data structure. When an HTTP request is issued to the web-server, the input events are encoded in the URL. The input events may be differentiated from one another by tagging a unique ID at the end of their parameter names. The IDs are used to differentiate one input event from another in a batch, and to provide ordering information to maintain the order of the events as generated by the user.

The following is an example of an event URL:

eventType=input&ioType_0=keyDown&keyCode_1=
200&ioType_1=keyUp&keyCode_2=200& ioCount=2

In this case, the user must have pressed the key with the keyCode 200, and followed by releasing it. The web-server will look at the eventType field and determine that the request is for input. It will then look at the ioCount, and query all ioType's from 0 to (ioCount−1) to find each input event.

### CONCLUSION

The above-described systems and methods enable a user to access a remote desktop or application using a browser without having to install remote desktop or remote application software or plug-ins. These and other techniques described herein may provide significant improvements over the current state of the art, potentially providing greater usability of server and server systems, reduced bandwidth costs, and an improved client experience with remote desktops or applications. Although the systems and methods have been described in language specific to structural features and/or methodological acts, it is to be understood that the systems and methods defined in the appended claims is not necessarily limited to the specific features or acts described. Rather, the specific features and acts are disclosed as exemplary forms of implementing the claimed systems and methods.

1. A method of updating a web resource displayed by a web browser to a user, the method comprising:
sending a request for at least one of a new web resource and an updated web resource representing at least one of a remote application and a remote desktop;
receiving images that represent at least portions of the at least one of the application and the desktop that have changed; and
displaying the at least one of the new web resource and the updated web resource representing the remote application or remote desktop without using a remote desktop/application plug-in or remote desktop/application software installed by the user.

2. The method of claim 1, wherein receiving images that represent at least the changed portions comprises:
receiving a list containing at least one image URL; and
receiving position information for the at least one image.

3. The method of claim 2, further comprising:
creating and positioning, by the web browser, an image object based on the list and position information received, and
pointing the URL of the created and positioned image objects to the URL identified in the received list.

4. The method of claim 3, further comprising:
fetching, by the web browser, the image identified by the URL, when the image is not in the web browser cache.

5. The method of claim 4, wherein the request is sent to a server and wherein the method further comprises:
identifying, by the server, the changed portions of the remote application or remote desktop; and
transmitting, by the server, the list and the position information related to the changed portions.

6. The method of claim 1, wherein receiving images that represent at least the changed portions comprises:
receiving position information for at least one image; and
receiving the at least one image as binary data.

7. The method of claim 6, further comprising:
creating and positioning, by the web browser, image objects based on the position information and binary data received.

8. The method of claim 7, wherein the request is sent to a server and wherein the method further comprises:
identifying, by the server, the changed portions of the remote application or remote desktop; and
transmitting, by the server, the position information and binary data related to the changed portions.

9. A method of batching input at a web browser, the method comprising:
receiving an input event by the web browser;
accumulating a plurality of received input events in a data structure; and
transmitting the accumulated input events when an object associated with a client-side script request is available.

10. The method of claim 9, wherein the data structure includes at least one of a list and a data base.

11. The method of claim 9, wherein the client-side script request comprises an XMLHTTP request.

12. The method of claim 9, wherein the data structure is an array type data structure.

13. The method of claim 9, further comprising:
checking the data structure for accumulated input events when the object finishes transmitting data; and
when the data structure contains input events, transmitting the accumulated input events.

14. The method of claim 9, wherein the object associated with a client-side script request comprises an XMLHTTP object, the method further comprising:
receiving the data sent by XMLHTTP object at a remote server;
extracting the plurality of input events from the data sent by the XMLHTTP object; and
using the extracted input events as an input into a remote desktop or application.

15. The method of claim 14, wherein the data sent by the XMLHTTP object is received by a web server, the method further comprising:
transmitting input event data from the web server to a terminal server using a terminal server client on the web server.

16. A method of updating graphics displayed by a web browser to a user, the method comprising:
receiving at least one updated image for a portion of a web resource; and
updating the displayed image of the web resource using double buffering, without using a remote desktop or remote application plug-in or other remote desktop or remote application software installed by the user.

17. The method of claim 16, wherein the double buffering comprises:
updating the displayed web page by placing the updated image in either a top DIV or a bottom DIV; and
swapping a z-order of the top and bottom DIVs.

18. The method of claim 16, further comprising:
when the updated image is in a cache of the web browser and is to be displayed by the web browser, receiving an image identifier that identifies a cached image to be displayed instead of receiving the updated image.

19. The method of claim 18, further comprising:
when the updated image is not in the cache of the web browser and is to be displayed by the web browser, requesting and receiving the updated image;
receiving an instruction to cache the received updated image; and
receiving an identifier for the cached updated image.

20. The method of claim 16, further comprising:
receiving a web resource where a name of the updated image or a URL of the updated image is a hash of the updated image; and
if the name or URL identifies an image cached by the web browser, using the image cached by the web browser; and
if the name or URL does not identify an image cached by the web browser, request the updated image.
